(19) United States
(12) Patent Application Publication
(10) Pub. No.: US 2008/0263188 A1
(43) Pub. Date: Oct. 23, 2008

(54) METHOD AND SYSTEM FOR MONITORING AND ANALYZING OF ROUTING IN IP NETWORKS

(75) Inventors: Daniel O. AWDUCHE, Fairfax, VA (US); David Taiyung Kao, Ashburn, VA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: VERIZON BUSINESS NETWORK SERVICES INC., Ashburn, VA (US)

(21) Appl. No.: 11/770,561

(22) Filed: Jun. 28, 2007

Related U.S. Application Data
(60) Provisional application No. 60/913,062, filed on Apr. 20, 2007.

(51) Int. Cl. G06F 15/173

(52) U.S. Cl. 709/223

(57) ABSTRACT

Exemplary embodiments include methods and systems for monitoring, analyzing, and troubleshooting of control plane dynamics of a network including collect data associated with the one or more probe modules associated with a network, store the data associated with the one or more probe modules, analyze the data associated with the one or more probes modules, and output a result of the analysis of the data associated with the one or more probe modules to one or more user devices.

### CROSS-REFERENCE TO RELATED APPLICATIONS

This patent application claims priority to U.S. Provisional Patent Application No. 60/913,062 filed Apr. 20, 2007, which is hereby incorporated by reference herein in its entirety.

### CROSS-REFERENCE TO RELATED APPLICATIONS

Routing problems are a growing concern for Internet Service Providers (ISPs) as the Internet and use of the Internet continues to grow. Routing of data may be controlled by routing protocols. Border Gateway Protocol (BGP) is a core routing protocol of the Internet. Intermediate System to Intermediate System (IS-IS or ISIS) is a protocol used by routers and other network devices for controlling the forwarding of data packets through the Internet. Reducing downtime or avoiding problems associated with routing and/or network devices is an increasing concern to the Internet Service Providers (ISPs). Conventional troubleshooting of routing problems typically requires a user to manually access each network element to collect information associated with a network, thus this process may be tedious and time consuming. Also, vast amount of information collected from each network element may be difficult to organize and manage by a user and thus often leads to forsaking valuable information. Further, conventional troubleshooting of routing problem typically requires a manual analysis of the collected information in order to construct temporal relationships among routing events.

### BRIEF DESCRIPTION OF THE DRAWINGS

Purposes and advantages of the exemplary embodiments will be apparent to those of ordinary skill in the art from the following detailed description in conjunction with the appended drawings in which like reference characters are used to indicate like elements, and in which:

FIG. 1 is a high level schematic of a system that may provide monitoring, analysis, and troubleshooting of control plane dynamics of a network in accordance with an exemplary embodiment;

FIG. 2 is a detailed schematic of a system that may provide monitoring, analysis, and troubleshooting of control plane dynamics of a network in accordance with an exemplary embodiment;

FIG. 3A is an alternative schematic of a system that may provide monitoring, analysis, and troubleshooting of control plane dynamics of a network with the system including an ISIS router and a BGP router in accordance with an exemplary embodiment;

FIG. 3B is an alternative schematic of a system that may provide monitoring, analysis, and troubleshooting of control plane dynamics of a network with the system including an ISIS router in accordance with an exemplary embodiment;

FIG. 3C is an alternative schematic of a system that may provide monitoring, analysis, and troubleshooting of control plane dynamics of a network with the system including a BGP router in accordance with an exemplary embodiment;

FIG. 3D is an alternative schematic of a system that may provide monitoring, analysis, and troubleshooting of control plane dynamics of a network with the system without an ISIS router and a BGP router in accordance with an exemplary embodiment;

FIG. 4 is a flow diagram of a method for monitoring, analysis, and troubleshooting of control plane dynamics of a network in accordance with an exemplary embodiment; and

FIG. 5 is a flow diagram of a method for monitoring, analysis, and troubleshooting of control plane dynamics of a network in accordance with an exemplary embodiment.

These and other embodiments and advantages will become apparent from the following detailed description, taken in conjunction with the accompanying drawings, illustrating by way of example the principles of the various exemplary embodiments.

### DETAILED DESCRIPTION OF EXEMPLARY EMBODIMENTS

A system and method in accordance with exemplary embodiments of the present disclosure may include collecting router data and/or other network routing device data, storing the data, and analyzing the data. The data may be displayed to a user via a user interface in response to commands received via the user interface. The displayed data may assist the user in real-time troubleshooting, post-event forensic analysis, and/or performing trend analysis of a network over a period of time. Moreover, reports may be generated for various reasons to inform a user of conditions in a network. Furthermore, an alert may be generated to provide warning of abnormal activity and/or instability in a network.

The description below describes servers, computers, terminals, client devices, and other computing devices that may include one or more modules, some of which are explicitly depicted, others of which are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, computers, etc.) separately. The functions described as being performed at various components may be performed at other components, and the various components may be combined and/or separated. Other modifications also may be made.

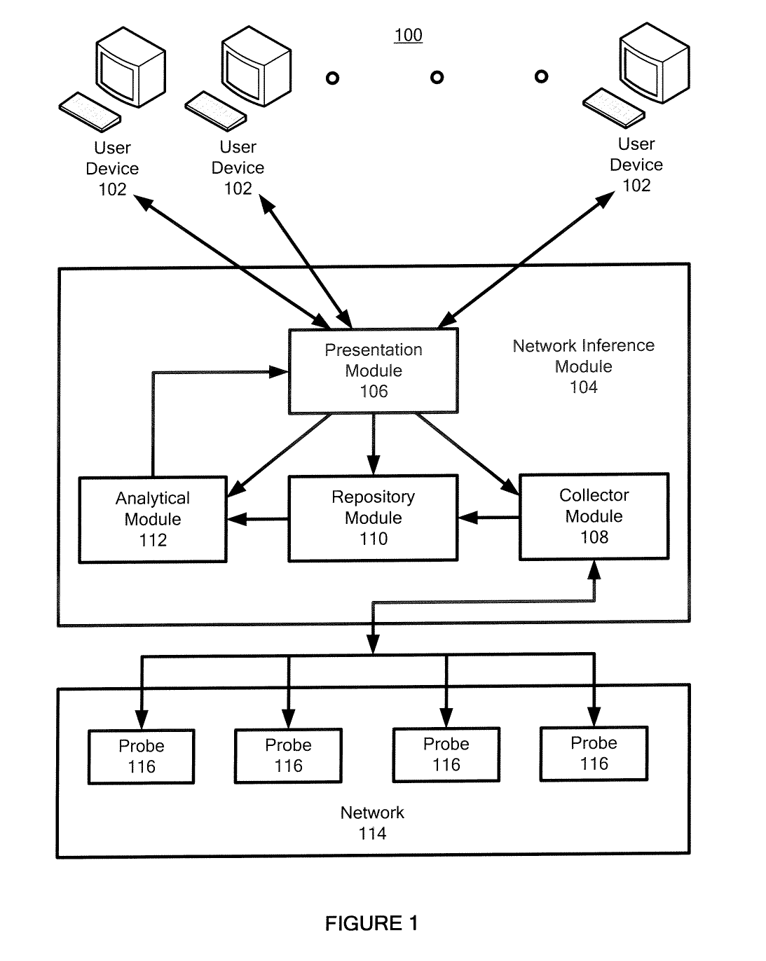

FIG. 1 illustrates an exemplary system 100 for monitoring, analysis, and troubleshooting of control plane dynamics of a network in accordance with an exemplary embodiment. Generally any system that may monitor one or more routing devices in a network may be used. The system may monitor the control dynamics based on one or more protocols. Protocols that may be used for monitoring the control dynamics may include, but are not limited to, Border Gateway Protocol (BGP), Enhanced Interior Gateway Routing Protocol (EIGRP), Intermediate System to Intermediate System (ISIS), and Open Shortest Path First (OSPF). It is noted that BGP and ISIS control plane monitoring are described below, however other protocols may be monitored in similar manners.

As illustrated in FIG. 1, system 100 may include one or more user devices 102 which may interact with a network 114 via a network inference module 104. A user may be associated with, but is not limited to, service providers, enterprises, educational institutions, government agencies, and any individual, group and/or organization running, maintaining and/or monitoring a network. Users within an organization may include, but are not limited to, network architects, engineers, planners, Network Operations Center (NOC) personnel, marketing, sales engineering, operations personnel, and customer support organizations. The one or more user devices 102 may be a computer, personal computer, laptop, or any other device that may allow a user to communicate with the network inference module 104 via one or more networks (not shown) as known in the art.

A user may interactively browse the network 114 to display various views of monitored network variables via one or more user devices 102. Various views monitored by a user may include a correlation between various parameters to highlight the interactions that may occur in the network 114, e.g., an Internet Protocol (IP) network, etc. For example, various views monitored by a user may include an “inside” and an “outside” views of routing in the network 114. An inside view may illustrate routing protocols, interactions between one or more network elements and/or transfer of data between one or more network elements viewed from a perspective of a network element within the network 114. Also, an inside view may illustrate interior routing dynamics, e.g., views of individual sub-autonomous-systems and/or individual network element within the network 114. Further, an inside view of the network 114 may include any hidden routing dynamics, complex detailed routing protocols and/or low-level routing protocols which may not be available to an outside view because of security reasons, proprietary reasons, regulation reasons, policy reasons and/or other reasons.

An outside view may include a view of the network 114 from a perspective of a user outside the network 114 and/or a peer network. An outside view may illustrate a customer's view of the network 114 and different customers may have different views of the network 114 based on service, monitoring and/or analysis provided to different customers. An outside view may also include view of the network 114 from a peer network and/or a network element outside of the network 114, e.g., from the perspective of an external network, etc. As mentioned above, an outside view of the network 114 may be limited in detail and/or amount of information shown compared to an inside view of the network 114. An inside view or an outside view or the combination thereof may provide a user with a detailed layout of the network 114 and thus facilitate the user in monitoring the network 114. Furthermore, an inside view and/or an outside view may provide a user a topology of the network 114 and thus easier for the user to detect instability within the network 114.

A network inference module 104 may be one or more servers, e.g., UNIX based servers. As shown, the network inference module 104 may include a collector module 108 which may collect data from the network 114. The collector module 108 may preprocess the data collected from the network 114, e.g., filter, format, aggregate, etc. The data may be transferred from the collector module 108 to a repository module 110. The repository module 110 may store and/or manage the data transferred from the collector module 108. An analytic module 112 may access the repository module 110 to obtain the data needed to perform one or more analyses, e.g., predetermined analysis. Finally, the data and/or the result of the one or more analyses may be automatically and/or upon a request by a user, transferred to a presentation module 106 and presented to a user via one or more user devices 102. A presentation module 106 may provide an interface between one or more user devices 102 and the network inference module 104. The presentation module 106 may include a user interface, e.g., a graphical user interface, to receive requests from the user and to provide information and/or data to the user via one or more user devices 102. The presentation module 106 may provide a unified graphical user interface where the presentation module 106 may provide a user with a unified view of one or more protocols e.g., unified view of BGP protocol and ISIS protocol. Thus, a user may monitor various protocols within a network without manually converting various protocols into a unified form.

In addition, the presentation module 106 may include an Application Programming Interface (API) to interact with one or more user devices 102. In response to receiving a request from a user via one or more user devices 102, the presentation module 106 may send requests (or control signals, etc.) to the collector module 108, the repository module 110, and the analytical module 112. In response to a request, the analytical module 112 may (a) receive data from repository module 110 and collector module 108, (b) analyze the data, and (c) provide data and/or analysis result to the presentation module 106. The presentation module 106 may provide the data and/or analysis results to one or more user devices 102 for display. As a result, system 100 may allow a user to monitor the network 114 in real-time and/or near real-time.

Moreover, the presentation module 106 may include a report generator module for generating reports. A report may be generated periodically, e.g., hourly, daily, weekly, monthly, yearly, etc, and may include date, time, various parameters and/or analysis in accordance to a user's request. Also, a report may be generated automatically when a user is logged into system 100 in order to update the user of operation and/or instability within the network 114 since the last time the user was logged into system 100. Further, a report may be automatically generated in the event of a catastrophic network overload, network outage, router failure, network instability and/or scheduled event. For example, an outage in the network 114 may occur during the previous day, a report may be generated automatically and/or upon a request by a user which may include, date, time, data and/or analysis associated with the outage in the network 114. Thus, a user may be informed of concerns, problems, and/or repairs that may be needed for the network 114.

Furthermore, the presentation module 106 may include an alert dispatcher for alerting one or more users in response to user-specified conditions. For example, a user may define a set of rules and/or conditions upon the occurrence of such rules and/or conditions, a report may be generated to alert the one or more users. Such a report may include date, time, one or more set of rules and/or conditions defined by a user, an analysis of data collected from the network 114, and/or status of various network elements. A user may be alerted in cases of instability in the operation of a network, failure of network element, network outage, achieving a predetermined threshold or value, one or more threshold-crossing events, data corruption, error in transferring data and/or other parameters requested by the user. For example, a user may monitor a variety of parameters which may include, but not limited to, number of ISIS routes, number of routers with an overload bit set, number of BGP prefixes, number of BGP churn, number of BGP prefixes received from a user, number BGP prefixes received from a peer network, absence of certain BGP prefixes, loss of BGP peer network connectivity and/or other parameters of a network. The dispatched alert can take various forms including, but not limited to, email, telephone call, and Simple Network Management Protocol (SNMP).

The collector module 108 may interact with one or more probes 116 in the network 114. Through these interactions, the dynamics of the network control plane may be captured from multiple perspectives as seen by one or more probes 116. For example, the collector module 108 may sequentially and/or simultaneously collect data from one or more probes 116. The collector module 108 may provide the data from each one or more probes 116 to the repository module 110. This data may include, but is not limited to, routing table size, route updates, and event logs. The collector module 108 may preprocess the data collected from one or more probes 116 before transferring the data to the repository module 110. Preprocessing of the data provided by the collector module 108 may include filtering data and eliminate undesired data, formatting data into useful format, and/or data aggregation where data is gathered and expressed in a summary form.

One or more probes 116 may be an element associated with a network element and/or a network element in the network 114, such as a router, and may communicate via the network control plane. One or more probes 116 may participate in the control plane dynamics in the monitoring of network 114, wherein one or more probes 116 may define and/or control various routing protocols between network elements within the network 114. Also, one or more probes 116 may collect data exchanged through routing protocols on a control plane of network 114. For example, data collected by one or more probes 116 may include, but not limited to, number of ISIS routes, number of routers with an overload bit set, number of BGP prefixes, number of BGP churn, number of BGP prefixes received from a user, number BGP prefixes received from a peer network, absence of certain BGP prefixes, loss of BGP peer network connectivity and/or other data of a network. Interactions may occur in response to a message or request from presentation module 106 and/or in response to a scheduling service as explained in further detail below. Also, one or more probes 116 may transfer protocol instructions and/or give protocol instructions between one or more network elements.

The repository module 110 may store and manage data from the collector module 108. The repository module 110 may provide an interface, e.g., a uniform interface, for other modules within the system 100 and may write, read, and search data in one or more repositories or databases. The repository module 110 may also perform other functions, such as, but not limited to, concurrent access, backup and archive functions. Also, due to limited amount of storing space the repository module 110 may compress the data stored within after a period of time, e.g., a month. The compression of the data stored within the repository module 110 may be achieved by reducing the precision of the data. For example, the data stored in the repository module 110 may include data taken every second. After the compression of the data, the repository module 110 may include data taken every 5 seconds and thus reducing the precision of the data. The repository module 110 may provide data to the analytical module 112.

The analytical module 112 may retrieve data from the repository module 110 and analyze such data. The analytical module 112 may further include a plurality of sub-analytical modules to perform various types of data analysis. The analytical module 112 may perform various analyses, such as, but not limited to, time series analysis, cross functional analysis, correlative analysis, forensic analysis, exploratory analysis, pattern matching analysis, and data mining analysis. For example, using one or more user devices 102, a user may select various types of data analyses to be performed. A user may select a time series data analysis where one or more parameters may be analyzed over a period of time. Also, a user may select cross functional data analysis where one or more parameters associated with a function may be analyzed with one or more parameters associated with a different function. Further, a user may select correlative data analysis where the correlation between plurality of parameters may be analyzed. Furthermore, a user may select forensic data analysis where a user may select to analyze an event occurred in the past. Moreover, a user may select exploratory data analysis where a user may explore relations between parameters and/or functions that previously may not be known to the user. In addition, a user may select pattern matching analysis where patterns associated with one or more parameters and/or functions may be matched with other parameters and/or functions. Finally, a user may select data mining analysis where a user may determine hidden useful information within a data set. Also, data mining analysis may include the analysis mentioned above and/or the combination thereof in order to determine the useful information. The analytic module 112 may summarize and aggregate data retrieved from the repository module 110 to provide a harmonized view of the routing dynamics from multiple perspectives. This allows a user to conduct exploratory data analysis interactively.

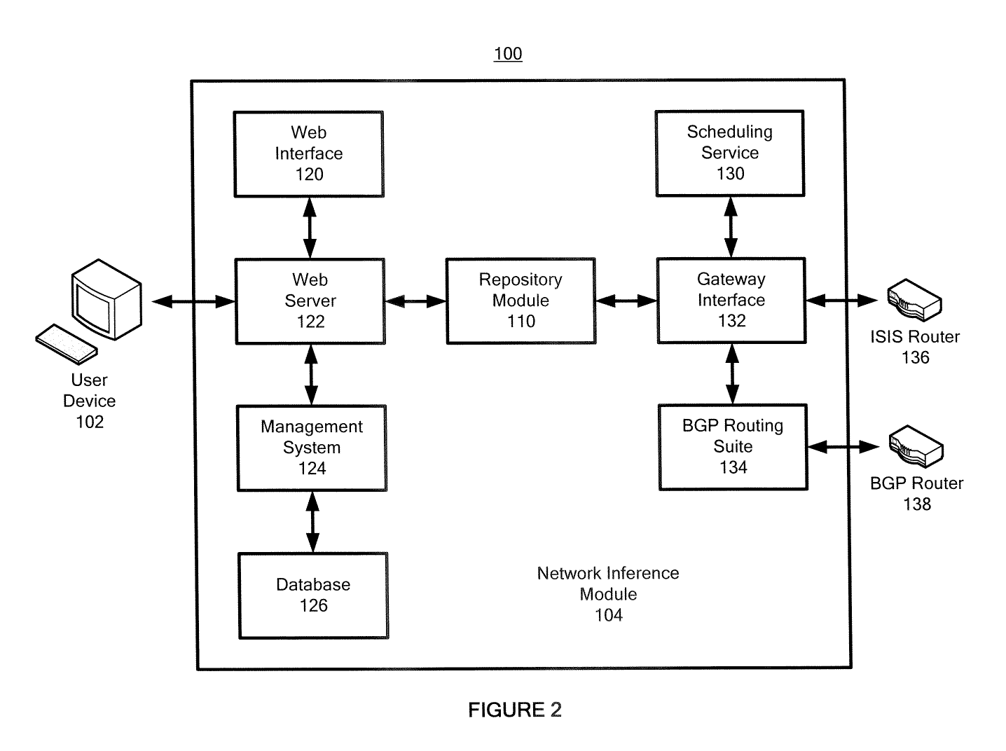

Referring to FIG. 2, a detailed schematic of a system that may provide monitoring, analysis, and troubleshooting of control plane dynamics of a network in accordance with an exemplary embodiment is illustrated. FIG. 2 is a more detailed view of network inference module 104 compared to FIG. 1. As shown, the presentation module 106 may include a web interface 120, a web server 122, a database management system 124, and a database 126.

The web interface 120 may include software code for interfacing with one or more user devices 102. For example, the software code may be source code written in HTML (HyperText Markup Language) and/or PHP (Hypertext Preprocessor). The software code may drive the web server 122 to provide and receive information to and from the user via one or more user devices 102. The web interface 120 may access data, such as system configuration and user authentication data from the database 126 via the web server 122 and the management system 124. The web interface 120 may access routing data from the repository module 110 via the web server 122. The web interface 120 may also be part of the analytical module 112 and perform analysis of the data in the repository module 110 and/or the database 126. The web server 122 may be a PHP-enabled Apache server. The web server 122 may interact with one or more user devices 102 and the network inference module 104 via one or more networks as known in the art. The management system or database management system 124 may manage one or more databases 126. Management system may be MySQL daemon and the database 126 may include one or more MySQL databases.

The repository module 110 may route the data files between the gateway interface 132 of the collector module 108 and the web server 122 of the presentation module 106. A software code may be associated with the gateway interface 132 which may include, but not limited to, Perl and Expect scripts, for retrieving data and processing data. The software code associated with the gateway interface 132 may interact with one or more ISIS routers 136 to retrieve ISIS routing data and may store the data as routing data files which are provided to the repository module 110. Also, the software code associated with the gateway interface 132 may be configured to filter, format, and aggregate the data prior to storing the routing data files. For example, using Expect scripts, the gateway interface 132 can retrieve ISIS router data through interactive applications such as Telnet, File Transfer Protocol (FTP), Secure SHell (SSH), etc. The software code associated with the gateway interface 132 further may interact with a BGP routing suite 134 to retrieve BGP routing data from one or more BGP routers via BGP connections and may store the data as routing data files which are provided to the repository module 110. The BGP routing suite 134 may be, for example, a ZebOS BGP daemon of ZebOS ARS (Advanced Routing Suite) by IP Infusion located in San Jose, Calif. A scheduling service 130 may trigger the gateway interface 132 to obtain data from the routers, e.g., ISIS routers 136 and/or BGP routing suite 134, at specific times, e.g., hourly or daily. The scheduling service 130, the gateway interface 132 and/or the BGP routing suite 134 may form the collector module 108. In alternate embodiments, one or more ISIS routers 136 may be part of the collector module 108. Similarly, the BGP router 138 may be part of the collector module 108.

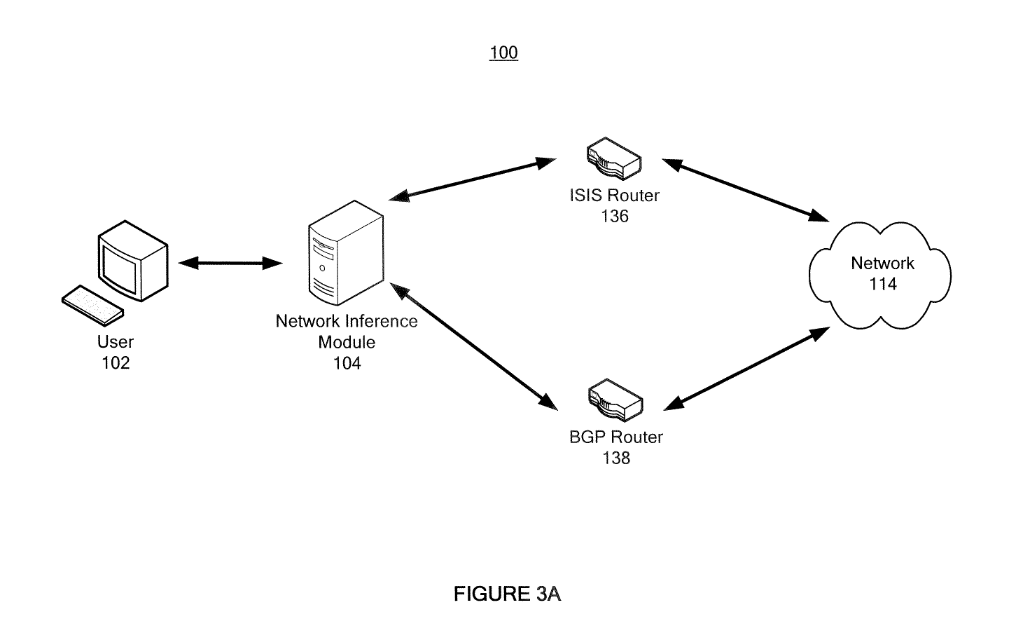

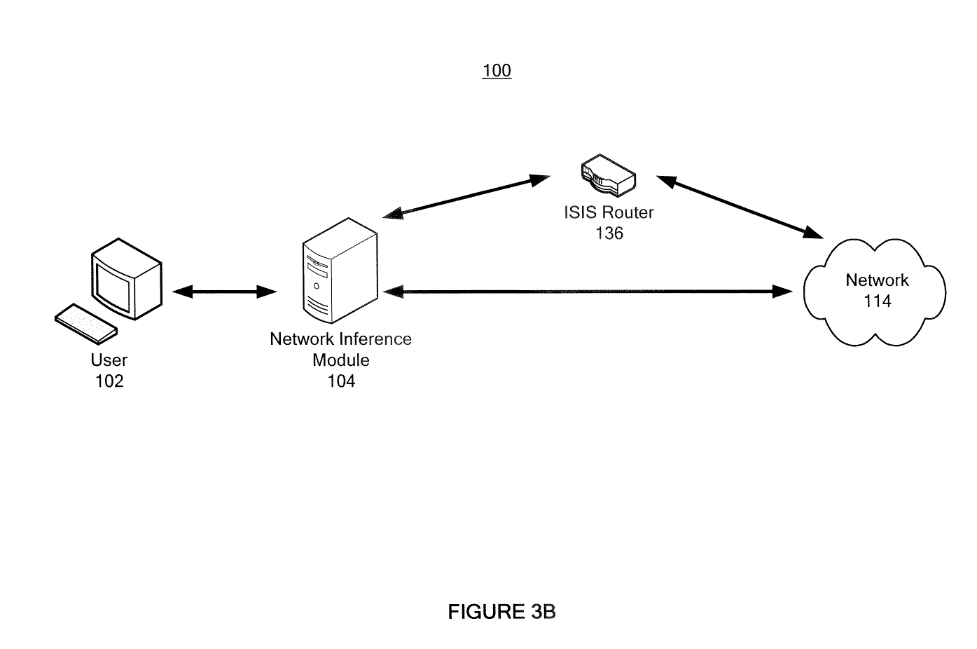

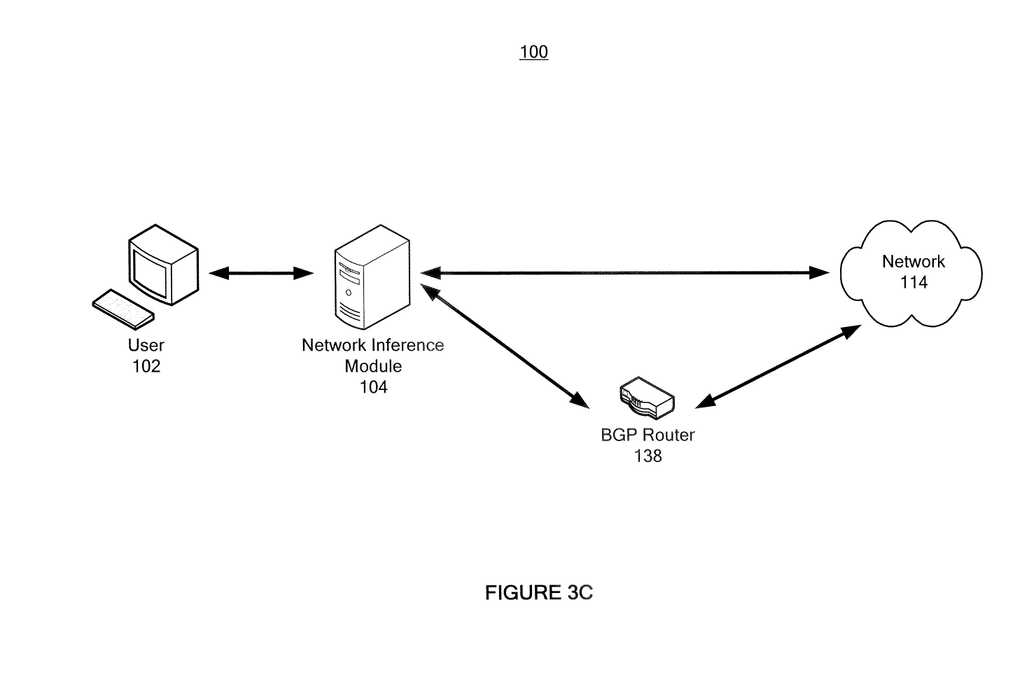

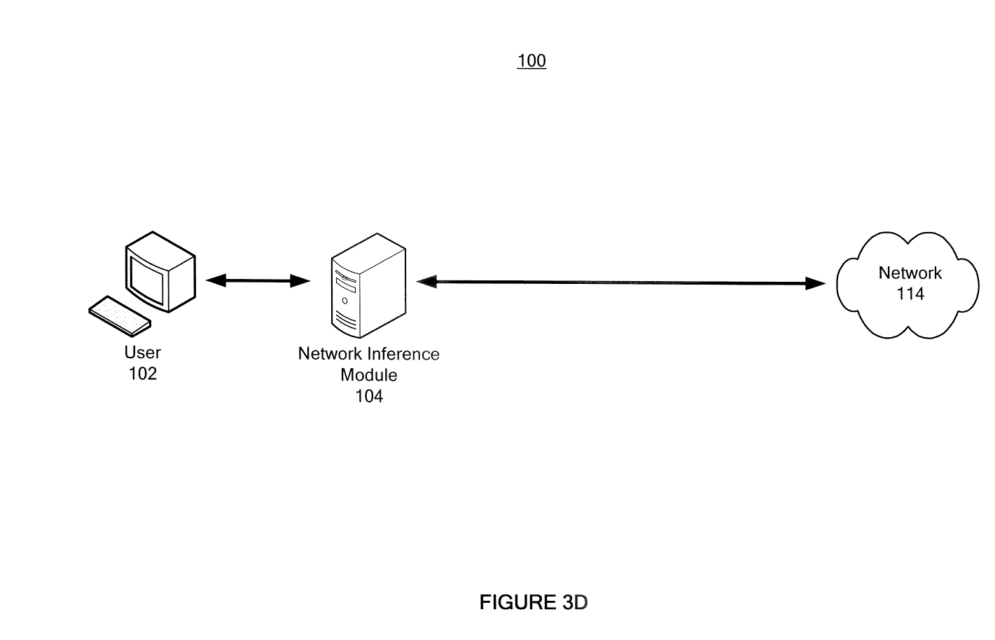

FIGS. 3A, 3B, 3C, and 3D illustrate alternative schematics of a system that may provide monitoring, analysis, and troubleshooting of control plane dynamics of a network with system 100 including and not including ISIS routers and BGP routers in accordance with exemplary embodiments of the present disclosure. Although only one ISIS router 136 and only one BGP router 138 are shown in some of these figures, additional ISIS routers 136 (and/or other ISIS network devices) and BGP routers 138 (and/or other BGP network devices) may be implemented in various embodiments. FIG. 3A includes both an ISIS router 136 and a BGP router 138. As shown in FIGS. 3A and 3B, the ISIS router 136 may be an intermediate ISIS router and may gather ISIS information from one or more probes 116, such as ISIS routers, in the network 114. The intermediate ISIS router may be a dedicated non-traffic-carrying router. The network inference module 104 may use one or more ISIS routers 136 to obtain link status information of ISIS devices in the network 114 which may be used to construct a topology of the network 114 with various topology state information sets. A topology of the network 114 may assign different weight for different connectivity between network elements. Also topology of the network 114 may be associated with various parameters which may include bandwidth, priority/preference and/or the role of the link in the network 114. The constructed topology and associated information may be displayed as a view to the user via one or more user devices 102. The network inference module 104 may retrieve ISIS routing information from the ISIS router 136 by tracing one or more log files and running one or more commands, e.g., Common Line Interface (CLI) commands. The ISIS router 136 may provide an extra layer of protection of ISIS routing in the network 114.

Referring to FIGS. 3A and 3C, BGP router 138 may be an intermediate BGP router and may gather BGP information from one or more probes 116, such as BGP routers, in the network 114. The intermediate BGP router may be a dedicated non-traffic-carrying router. The BGP router 138 may participate in BGP routing and may log BGP routing events using one or more commands, e.g., CLI commands. For example, the BGP router 138 may establish BGP neighbor relationships with operational routers in the network 114, obtain the BGP routing updates, and store the associated data. The network inference module 104 may access the stored BGP data and may correlate the data with other data to provide a view of the dynamic properties of the network 114.

Referring to FIGS. 3B and 3D, the network inference module 104 may include the functionality of the BGP router 138, thereby interacting with one or more probes 116, e.g., BGP devices in the network 114, directly. For example, the gateway interface 132 and/or the BGP routing suite 134 may include the functionality of the BGP router 138. Similarly, as illustrated in FIGS. 3C and 3D, the network inference module 104 may include the functionality of the ISIS router 136, thereby interacting with one or more probes 116, e.g., ISIS device in the network 114, directly. For example, the gateway interface 132 may include the functionality of the ISIS router 136.

The network inference module 104 may retrieve data from one or more probes 116 via collecting agents, e.g., gateway interface 132, ISIS router 136, BGP routing suite 134 and/or BGP router 138, and may download the retrieved data into the repository module and/or the database 126. The collecting agents may interact with one or more probes 116 in the network 114 through control plane connectivity. One or more probes 116 in this case may select routers and/or other network devices in the network 114. For example, the ISIS router 136 forms ISIS adjacency to one or more ISIS routers or ISIS devices in the network 114. The ISIS adjacency is a form of control plane connectivity on which the ISIS protocol is used for exchanging information. ISIS routing information of the network 114 is learned by the ISIS router 136 through the ISIS adjacency. Depending on the network 114, ISIS router 136 may only need to form a single ISIS adjacency to the network 114 to get the ISIS dynamics on the control plane of the network 114. Also, ISIS router 136 may need to form multiple ISIS adjacencies. Such connections may be between the ISIS router 136 directly to each ISIS router or ISIS device in the network 114 or may be indirectly through one or more ISIS routers or ISIS devices in the network 114.

To collect BGP information, the BGP collecting agent, e.g., BGP routing suite 134 or BGP router 138, may use one or more BGP connections to one or more BGP routers or BGP devices in the network 114. The BGP connection is a form of control plane connectivity on which the BGP protocol may be used for exchanging information. BGP routing information of the network 114 is learned by the BGP collecting agent forming a BGP connection with one or more BGP routers in the network 114. Depending on the network 114, the BGP collecting agent may need to have multiple BGP connections to the network 114 to get the BGP dynamics on the control plane of the network 114. Such connections may be between the BGP collecting agent directly to each BGP router or BGP device in network 114 or may be indirectly through one or more routers or network devices in the network 114.

Once data is collected, the data may be downloaded to the repository module 110. This may occur in multiple manners. In one example, scheduling service 130, at a predetermined time interval, e.g., every 5 minutes, may invoke the execution of a specific combination of routines in gateway interface 132 thereby causing ISIS router 136 to download specific ISIS information from one or more probes 116 in the network 114. The ISIS router 136 may preprocess the data, format the data, and provide the data to the repository module 110 as routing data files. The BGP data may be downloaded in a similar manner.

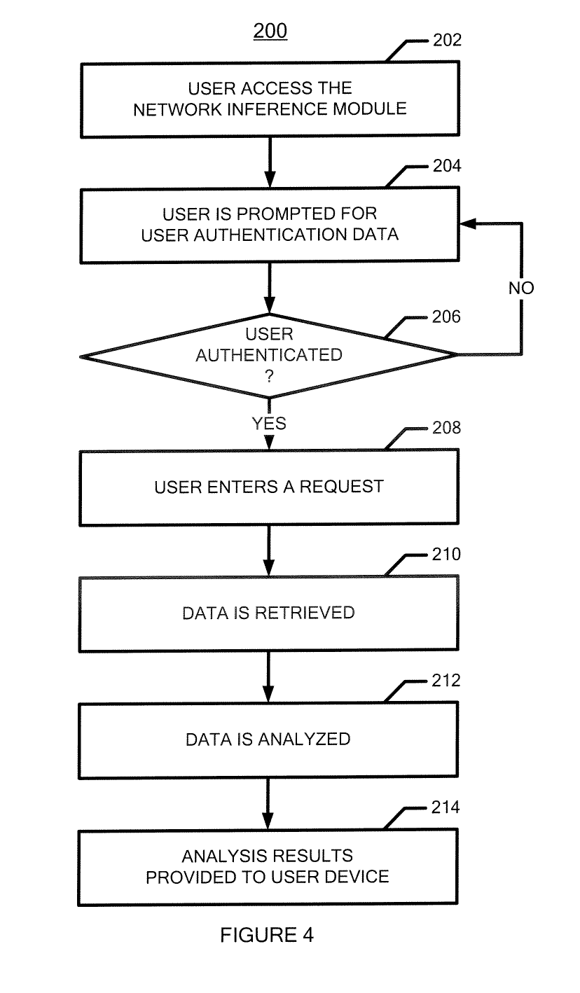

FIG. 4 illustrates a flow diagram of a method for monitoring, analysis, and troubleshooting of control plane dynamics of a network in accordance with exemplary embodiments. This exemplary method 200 is provided by way of example, as there are a variety of ways to carry out methods according to the present disclosure. The method 200 shown in FIG. 4 can be executed or otherwise performed by one or a combination of various systems. The method 200 is described below may be carried out by system 100 shown in FIGS. 1, 2, 3A, 3B, 3C, and 3D by way of example, and various elements of the system 100 are referenced in explaining the example method of FIG. 4. Each block shown in FIG. 4 represents one or more processes, methods or subroutines carried in exemplary method 200. Referring to FIG. 4, exemplary method 200 may begin at block 202.

At block 202, a user device may access a network inference module 104. For example, a user using one or more user devices 102 which includes a web browser accesses a network inference module 104 via a web server 122. After accessing the web server 122, the method 200 may proceed to block 204.

At block 204, a user may be prompted to enter authentication data. For example, a web interface 120 may cause the web server 122 to display a request for the user of one or more user devices 102 to enter a user name and user password. After prompting the user for authentication data, the method 200 may proceed to block 206.

At block 206, the user may be authenticated. For example, web server 122 may obtain user authentication data from a database 126 via a database management system 124. Web interface 120 may compare the authentication data from the user with the authentication data from database 126. If the authentication fails, the user may be prompted again or the method may end, for example, after a predetermined number of failures (e.g. three failures). If the authentication is successful, the user is provided access to network inference module 104 and the method 200 may proceed to block 208.

At block 208, a user may enter a request in response to a prompt. For example, using one or more user devices 102, the user may request various types of analysis mentioned above, e.g., a time series analysis on ISIS routing over a particular time period. This request may be accomplished via drop down menus or other means as known in the art. After receiving the request, the method 200 may proceed to block 210.

At block 210, data based on the request is retrieved. For example, web server 122 may obtain ISIS routing data for the given time period from the repository module 110. After receiving the requested data, the method 200 may proceed to block 212.

At block 212, the retrieved data is analyzed. For example, web server 122 may invoke one or more time series analysis routines from web interface 120 and may apply the routines to the ISIS data. After analyzing the ISIS data, the method 200 may proceed to block 214.

At block 214, the analysis results are provided to the user. For example, web server 122 provides the analysis results to one or more user devices 102 associated with the user who requested the analysis. The web server 122 may cause one or more user devices 102 to display the results of the analysis to the user. The method 200 may return to block 208 where the user is prompted for a request with the method 200 proceeding from there or the method 200 may end as known in the art based on such a request.

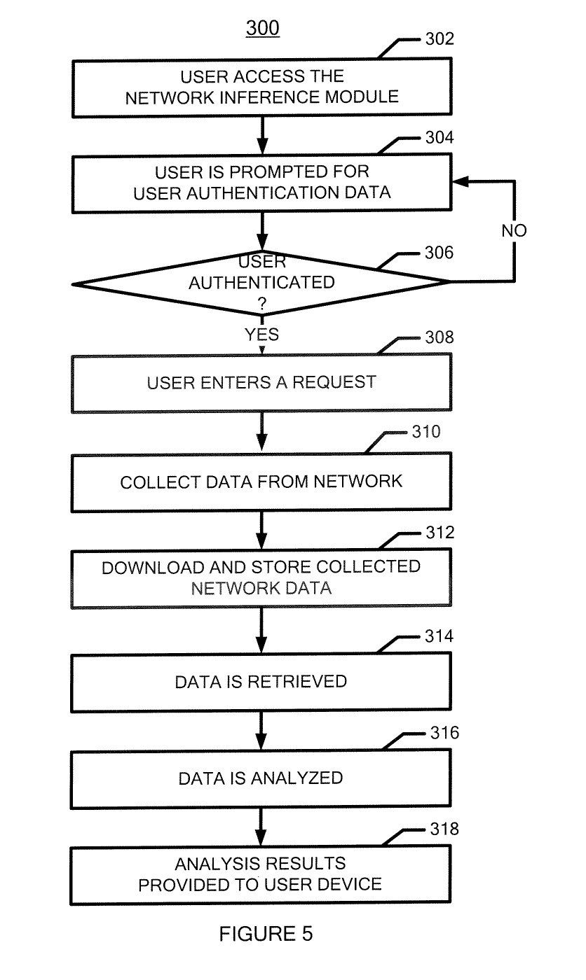

FIG. 5 illustrates a flow diagram of a method for monitoring, analysis, and troubleshooting of control plane dynamics of a network in accordance with exemplary embodiments. This exemplary method 300 is provided by way of example, as there are a variety of ways to carry out methods according to the present disclosure. The method 300 shown in FIG. 5 can be executed or otherwise performed by one or a combination of various systems. The method 300 is described below may be carried out by system 100 shown in FIGS. 1, 2, 3A, 3B, 3C, and 3D by way of example, and various elements of system 100 are referenced in explaining the example method of FIG. 5. Each block shown in FIG. 5 represents one or more processes, methods or subroutines carried in exemplary method 300. Referring to FIG. 5, exemplary method 300 may begin at block 302.

At block 302, a user device may access a network inference module 104. For example, a user using one or more user devices 102 which includes a web browser accesses network inference module 104 via a web server 122. After accessing web server 122, the method 300 may proceed to block 304.

At block 304, a user may be prompted to enter authentication data. For example, a web interface 120 may cause web server 122 to display a request for the user of one or more user devices 102 to enter a user name and user password. After prompting the user for authentication data, the method 300 may proceed to block 306.

At block 306, the user may be authenticated. For example, web server 122 may obtain user authentication data from a database 126 via a database management system 124. Web interface 120 may compare the authentication data from the user with the authentication data from database 126. If the authentication fails, the user may be prompted again or the method may end, for example, after a predetermined number of failures (e.g. three failures). If the authentication is successful, the user is provided access to network inference module 104 and the method 300 may proceed to block 308.

At block 308, a user may enter a request in response to a prompt. For example, using one or more user devices 102, the user may request various types of analysis mentioned above, e.g., a forensic analysis on instability of network 114 over a particular time period. This request may be accomplished via drop down menus or other means as known in the art. Also, a user may enter a request for monitor the operation of the system. A user may specify various rules and/or conditions and a report may be generated upon the occurrence of the user's specified rules and/or conditions to inform the user the status of network 114. Moreover, an alert may be generated upon the occurrence of the user's specified rules and/or conditions to alert the user. After receiving the request, the method 300 may proceed to block 310.

At block 310, a collector module 108 may retrieve network data from one or more probes 116 located within a network 114 based at least in part on the user specified rules and/or conditions. For example, a user may request a report and/or an alert in the event of one or more network elements failures for two seconds. Collector module 108 may sequentially or simultaneously retrieve network data from each of the one or more probes 116 in a time interval less than the user's specified time interval, e.g., every second, every half second, every quarter second, etc. A one (“1”) may represent one or more network elements is functioning properly and a zero (“0”) may represent one or more network elements failed. The data collected by collector module may be processed include filtering, formatting and/or aggregating. After collecting network data, the method 300 may proceed to block 312.

At block 312, the processed and/or unprocessed network data may be download from the collector module 108 and stored and managed by a repository module 110. The repository module 110 may also perform other functions, such as, but not limited to, concurrent access, backup and archive functions. After the network data is downloaded and stored, the method 300 may proceed to block 314.

At block 314, network data based on the user's request is retrieved. For example, a user may request a report and/or an alert in the event of one or more network elements failures for two seconds. A web server 122 may obtain network data associated with the user's specified rules and/or conditions from repository module 110. After receiving the requested data, the method 300 may proceed to block 316.

At block 316, the retrieved network data is analyzed. For example, web server 122 may invoke one or more analysis routines from web interface 120 and may apply the routines to the retrieved network data. For example, a user may request a report and/or an alert in the event of one or more network elements failures for two seconds. The web server 122 may analyze the network data in which examining consecutive zeros in the network data. If collector module 108 collected network data every second, two consecutive zeros may demonstrate one or more network elements failed for two seconds, four consecutive zeros for network data collected every half second and so forth. After analyzing the data associated with network instability, the method 300 may proceed to block 318.

At block 318, a report and/or an alert of the analysis results may be provided to the user upon the occurrence of the user's specified rules and/or conditions. For example, web server 122 may provide a report and/or an alert of the analysis results to one or more user devices 102 associated with the user who requested the report and/or alert. The web server 122 may cause one or more user devices 102 to display a report and/or alert of the results of the analysis to the user upon the occurrence of the user's specified rules and/or conditions. The method 300 may return to block 308 where the user is prompted for a request with the method 300 proceeding from there or the method 300 may end as known in the art based on such a request.

In the preceding specification, various preferred embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

What is claimed:

1. A system comprising:
a collector module configured to collect data associated with one or more probe modules associated with a network;
a repository module configured to store the data associated with the one or more probe modules;
an analytical module configured to analyze the data associated with the one or more probes modules; and
a presentation module configured to output a result of the analysis of the data associated with the one or more probe modules.

2. The system of claim 1, wherein the one or more probes associated with the network comprises a router.

3. The system of claim 1, wherein the one or more probes associated with the network is further configured to participate in a routing protocol of the network.

4. The system of claim 3, wherein the routing protocol of the network comprises at least one of Border Gateway Protocol (BGP), Enhanced Interior Gateway Routing Protocol (EIGRP), Intermediate System to Intermediate System (ISIS), and Open Shortest Path First (OSPF) protocol.

5. The system of claim 1, wherein the one or more probes associated with the network is located in a control plane of the network.

6. The system of claim 1, wherein the collector module is further configured to process the data associated with the one or more probes.

7. The system of claim 6, wherein processing the data associated with the one or more probes comprises at least one of filtering, formatting and aggregating the data.

8. The system of claim 1, wherein the analytical module is further configured to perform at least one of data mining analysis, pattern matching analysis, time series analysis, correlative analysis and exploratory analysis.

9. The system of claim 1, wherein the presentation module comprises an alerting module configured to alert a user based at least in part on one or more parameters specified by the user.

10. The system of claim 1, wherein the presentation module is further configured to generate a report based at least in part on one or more parameters specified by a user.

11. The system of claim 1, wherein the presentation module is further configured to provide at least one of an inside view of the network and an outside view of the network.

12. The system of claim 1, further comprises one or more user devices to display the result of the analysis.

13. A method, comprising:
collecting data from the one or more probes associated with the network;
storing the data collected from the one or more probes associated with the network;
analyzing the data collected from the one or more probes associated with the network;
outputting a result of the analysis of the data collected from the one or more probes associated with the network.

14. The method of claim 13, further comprises locating one or more probes associated with a network.

15. The method of claim 14, further comprises the one or more probes associated with the network participating in a routing protocol of the network.

16. The method of claim 14, further comprises locating the one or more probes associated with the network in a control plane of the network.

17. The method of claim 13, further comprises processing the data collected from the one or more probes associated with the network.

18. The method of claim 17, wherein processing the data collected from the one or more probes associated with the network comprises at least one of the filtering, formatting and aggregating the data.

19. The method of claim 13, wherein analyzing the data collected from the one or more probes associated with the network further comprises performing at least one of data mining analysis, pattern matching analysis, time series analysis, correlative analysis and exploratory analysis.

20. The method of claim 13, further comprises alerting a user based at least in part on one or more parameters specified by the user.

21. The method of claim 13, further comprises generating a report based at least in part on one or more parameters specified by a user.

22. A computer readable media comprising code to perform the acts of the method of claim 13.
